(19) United States
(12) Patent Application Publication
(10) Pub. No.: US 2010/0298011 A1
(43) Pub. Date: Nov. 25, 2010

(54) Method and Appartus for Remote Software Installation and Execution on a Mobile Device

(75) Inventors: Edward S. Pelley, Cedar Park, TX (US); William W. Wallace, Austin, TX (US); Chris Ferlita, Austin, TX (US); Amarjit Singh, Austin, TX (US); Bryan Tacker, Austin, TX (US)

Correspondence Address: Docket Administrator - Room 3D-201E;Alcatel-Lucent USA Inc., 600-700 Mountain Avenue, Murray Hill, NJ, 07974, US

(73) Assignee: Alcatel-Lucent USA Inc., Murray Hill, NJ (US)

(21) Appl. No.: 12/650,064

(22) Filed: Dec. 30, 2009

Related U.S. Application Data
(60) Provisional application No. 61/216,715, filed on May 19, 2009.

(51) Int. Cl. H04W 4/12

(52) U.S. Cl. 455/466

(57) ABSTRACT

A method and apparatus for remotely installing and executing software on a mobile device. A work item is formed that includes the software to be installed and executed, and a remote-execution command message is sent to the mobile device. The mobile device authenticates the remote-execution command message before extracting the remote-execution command and using it to request a download of the work item. The remote-execution command message is preferably an SMS message including a hook so that it is quickly recognizable as a remote-execution command message by the mobile device. When the work item arrives, it is authenticated before it is executed. When the mobile device determines that the execution is complete, it sends a notification to the remote-execution server.

### CROSS-REFERENCE TO RELATED APPLICATIONS

The present disclosure is related to and claims priority from U.S. Provisional Patent Application Ser. No. 61/216,175, entitled System for remote Software Installation/Execution on a Mobile Device and filed on 14 May 2009, the entire contents of which are incorporated by reference herein.

### TECHNICAL FIELD

The present invention relates generally to the field of mobile communications, and, more particularly, to a method and apparatus for remotely and securely executing software on a mobile electronic communication device.

### BACKGROUND

Mobile electronic communication devices are now ubiquitous. Whereas in the recent past even simple portable telephones were relatively rare, nowadays many people carry multiple electronic devices. Mobile electronic communication devices, sometimes referred to herein simply as mobile devices, now includes cellular and satellite telephones, two-way pagers and messaging devices, and PDAs (personal digital assistants). Although not all portable electronic devices have communication capability, an increasing number of them do. As will be apparent, the present invention advantageously applies to electronic devices with wireless communication capability. In general, these mobile devices communicate use RF (radio frequency) channels, although other media are available and may become more prevalent in the future.

In one common scenario, a wireless service provider provides a network of interconnected switching stations for routing communications to and from mobile device users who subscribe to the service. The wireless network also includes gateways for connecting to other communication networks, so that subscribers can communicate not only with each other, but with non-subscribers as well. Typically, the network components such as switches and gateways are connected to each other using wires, fiber optic cables, and other high-capacity media. Mobile devices, on the other hand communicate over RF channels with widely-dispersed base stations and wireless access points, which themselves are connect to the network.

As mobile devices have become more common, they are also becoming more capable and can perform functions well beyond simply making telephone calls and sending text messages. Although the underlying technology has improved dramatically, the demands of the many new functions still pose design challenges. The capacity of each device remains limited by the fact that it needs to remain small and portable, so there are limits to the capabilities each individual device can have. In addition, new features are always being developed. For these reasons, wireless service providers often have a need to adjust the configuration of existing devices. This is preferably done remotely, so that subscribers do not have to send back their devices or bring them to a service center for reconfiguration.

Wireless providers therefore need a mechanism to remotely execute software on mobile devices that are already in the possession of subscribers. This may be done, for example, to deploy new software applications, to execute a diagnostic routine if there are problems with a device, or to present new products to the subscriber.

Generally, however, remotely executing software on a mobile device requires user intervention. This may be cumbersome and error-prone due to a lack of technical skills among some parts of the user base. In a few cases a given user could be manually guided through the required steps of manually downloading and executing software package, but most of the time this would be impractical. Many users are pressed for time or have limited interested in seeing the execution done properly.

Therefore there is a need, especially by wireless providers, for a mechanism to remotely execute applications on the mobile devices used by subscribers. As might be expected, this process must be secure enough to frustrate parties with malicious intent if they attempt to exploit one or more aspects of this solution to remotely deploy malware to a mobile device. The solution should be efficient and require little or no involvement by the subscriber. These needs and other needs are satisfied by the present invention.

### SUMMARY

The present invention is directed to a manner of remotely performing modifications to a mobile device in an efficient and secure manner through the remote execution of software, preferably with no participation by the subscriber or, optionally, with minimal supervision.

In one aspect, the present invention is a method for remotely executing software on a mobile device, including forming a work item that includes the software to be installed and executed, transmitting a remote-execution command message to the mobile device, receiving a work-item request from the mobile device, and transmitting the work item to the mobile device in response to the work-item request. The remote-execution command message is preferably an SMS message including a hook so that it is quickly recognizable as a remote-execution command message. The method may also include inserting an authentication signature in the remote-execution command message and the work item. In some embodiments, the method may also include recording a record entry indicating the status of the installation. Finally, in this aspect the method may include transmitting a query to the mobile device if a message indicating successful execution has not been received within a predetermined time subsequent to transmitting the work item.

In another aspect, the present invention is a method for remotely executing software on a mobile device, including receiving a remote-execution command message at the mobile device, confirming the integrity of the remote-execution command message, transmitting a work item request if the integrity of the remote-execution command message is confirmed, receiving a work item, confirming the integrity of the work item, if required, and executing the work item. Again in this aspect the remote-execution command message is preferably an SMS message including a hook so that it is quickly recognizable as a remote-execution command message. The method may also include determining whether the work item has been successfully executed and transmitting a remote-execution status report message. The method according to this aspect may also include transmitting an additional work-item request if it is determined that the work item has not been successfully executed.

In yet another aspect, the present invention is a mobile device for use in the remote execution of software on the mobile device, including a controller for controlling the components of the mobile device, transmit circuitry, receive circuitry, and an antenna for wireless communication, an SMS message analyzer for analyzing received SMS messages to determine if they are remote-execution command messages, a remote-execution command extractor for extracting the remote-execution commands if they are. The mobile device of the present invention further includes a work-item request generator used to generate work-item requests, an authentication module for confirming the integrity of received remote-execution command messages and work items. The mobile device may also include a work-item status determiner to determine whether a work item has been successfully executed and a work-item status message generator for generating a message reporting whether the execution was successful.

In yet another aspect, the present invention is a remote-execution server for remotely executing software on a mobile device including a work-item generator for forming a work item comprising software, a remote-execution command message generator for generating a message to instruct the mobile device to download the work item, an authentication module for inserting authentication signatures in work items and remote-execution command messages prior to transmission, a network interface for transmitting work item and the remote-execution command message prior to transmission, and a controller for controlling the components of the remote-execution server.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a wireless communication network that may communicate with a mobile device according to an embodiment of the present invention;

FIG. 2 is a flow diagram illustrating a method of remotely executing software on a mobile device according to an embodiment of the present invention;

FIG. 3 is a flow diagram illustrating a method of remotely executing a software application on a mobile device according to another embodiment of the present invention;

FIG. 4 is a flow diagram illustrating a method of remotely executing a software application on a mobile device according to another embodiment of the present invention;

FIG. 5 is a simplified block diagram illustrating selected components of a mobile device according to an embodiment of the present invention; and

FIG. 6 is a simplified block diagram illustrating selected components of a remote-execution server according to an embodiment of the present invention.

### DETAILED DESCRIPTION

Embodiments of the present invention are directed to a manner of remotely performing modifications to a mobile device in an efficient and secure manner. The mobile device referred to here is an electronic mobile device operable to communicate with one or more communication networks. The device is typically portable, that is, small enough to be conveniently carried about by a subscriber and generally capable of establishing and maintaining network communications even while traveling from place to place, to the extent a network is within range and a channel available. Communications between the mobile device and the network or networks are typically though not necessarily via an RF (radio frequency) channel.

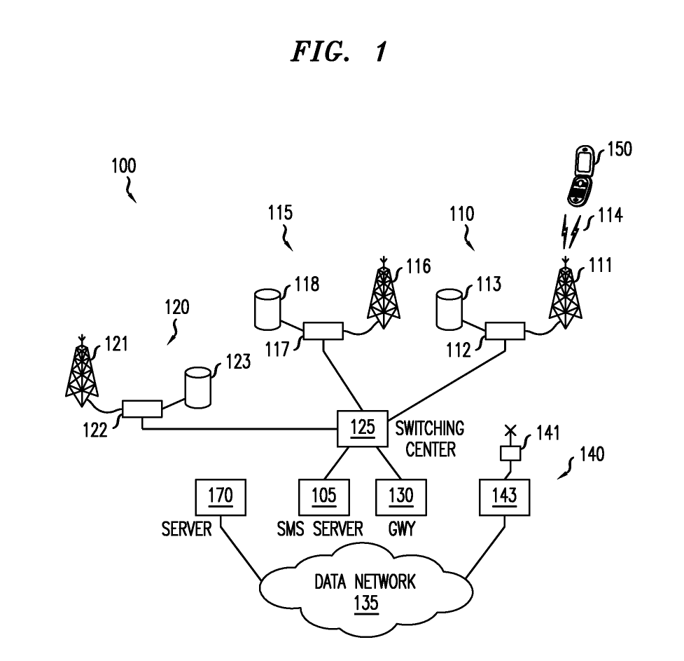

One such network is illustrated in FIG. 1. FIG. 1 is a simplified schematic diagram illustrating selected components of a wireless communication network 100 that may communicate with a mobile device according to an embodiment of the present invention. The communication with mobile device 150 may, for example, be conducted over air interface 114 with base station 110, which is equipped with an antenna 111 and a controller 112 for this purpose. A register 113 is maintained at or accessible to controller 112 stores information about mobile devices in the area. Air interface 114 may include a number of RF channels, for example for uplink and downlink traffic. These channels are assigned on an ad hoc basis when communication between the base station 110 and mobile device 150 is to take place, and may be otherwise assigned to different mobile stations (not shown) in the area.

Similarly, base stations 115 and 120 include, respectively, antennas 116 and 121, controllers 117 and 122, and registers 118 and 123 for communicating with mobile device 150 when and if it relocates. Mobile devices typically but not necessarily communicate with the nearest base station, and communications are handed over from one base station to another as necessary. Network protocols are followed in an attempt to ensure that an in-progress communication session is not dropped during handover. Mobile devices not in an active communication session nevertheless periodically register with network 100 so that it may keep track of their current location and route subsequent communications accordingly.

Base stations 110, 115, and 120 are connected to a switching center 125 for routing mobile-device communications between the base stations and the remainder of wireless network 100 (which is typically much more extensive that the limited extent shown in FIG. 1). Switching center 125 is associated with a register so that it can, among other things, keep track of the mobile devices that have registered at base stations with which the switching center 125 is in communication. Wireless network 100 may include other switching centers as well (not shown), each of which will be directly or indirectly connected to switching center 125. Communications involving mobile devices communicating exclusively through base stations 110, 115, and 120 may be handled by switching center 125 itself, and those involving other base stations may be handled through the cooperation of their respective associated switching centers.

For communicating with other (generally non-wireless network) entities, switching center 125 communicates with a gateway 130, through which communications may be routed to and from, for example, a data network 135 (represented in FIG. 1 by a cloud). For convenience, only one gateway is shown in FIG. 1, though there may in fact be several for communicating with various other networks and entities.

Also illustrated in FIG. 1 is a wireless access network 140. As shown here, wireless access network includes a single access point 141, which is in communication with access server 143. Access server 143, which in practice will normally serve a number of access points, is also connected to data network 135. Of course, this is a simplified representation of an access network and many other components may be present as well.

Mobile station 150 may communicate with wireless network 100 and access network 140 for different reasons. Voice communications, for example, are typically carried through wireless network 100, and SMS messages as well. SMS messages are relatively-short text or data strings that are advantageously sent via networks used primarily for voice. Because, unlike voice, they do not need to be sent immediately, SMS messages make efficient use of existing bandwidth by being held until a channel is available, and then being transmitted very quickly. In FIG. 1 an SMS message center is illustrated, in communication with both switching center 125 and gateway 130. Again, these relationships are exemplary, and other configurations are possible.

Access network 140, on the other hand, may more typically be used for accessing the World Wide Web on the Internet, for the purpose of, for example, visiting Web sites and accessing email. Presently, wireless access via an access network is more limited compared with access via the wireless network because the latter has extensive infrastructure. This may be changing, however, and more and more ways to obtain wireless access are being installed.

As an example for describing the present invention, it will be presumed that an application server 170 is attempting not only to communicate with mobile device 150, but to remotely install and execute software. This software is to transform the configuration of the mobile device for a specific purpose or purposes. These purposes may include, for example, installing a new application, conducting a diagnostic routine, or presenting a new product or service offering. As mentioned above, it is an advantage to effect this transformative reconfiguration securely and with little or no subscriber involvement. A process according to the present invention will now be described.

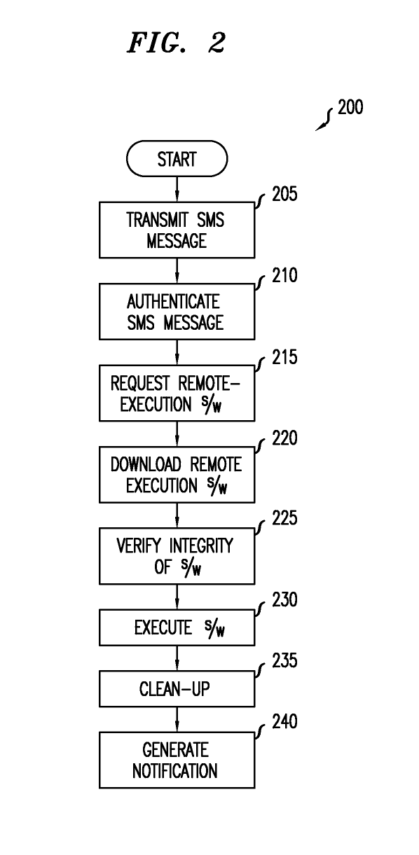

FIG. 2 is a flow diagram illustrating a method 200 of remotely executing software on a mobile device according to an embodiment of the present invention. As mentioned above, a mobile device will in this context be understood to be an electronic device capable of communicating though a communication network, such as a cellular telephone. At START, it is assumed that the equipment necessary for performing the method, for example, a communication network or networks, is available and operational. The process then begins with the transmission (step 205) of an SMS message containing a remote-execution command. The integrity of the SMS message is verified (step 210), preferably including its authenticity and lack of tampering. The remote-execution command is then used to request (step 215) that the remote-execution software application be transferred to the mobile device (step 220).

In response, the remote-execution application is downloaded to the mobile device, and its integrity is verified (step 225). The remote-execution software application is then executed (step 230) by the mobile device. After execution, the application and any temporary data files are deleted (step 235), a process sometimes referred to as clean-up. In some embodiments, a remote-execution notification is generated (step 240) for confirming that the process has been completed.

In this manner an application may be securely and remotely executed on a mobile device by, for example, the wireless service provider without the need for participation by the subscriber associated with the mobile device. In this regard it is noted that the subscriber's participation is not proscribed by operation of the present invention, but the level of participation is under the control of the wireless provider. For example, the downloaded software application could include user notifications or queries at various points in the process. In that case it may be also be specified whether the subscriber's participation is required for execution of the particular application, or optional. The processes illustrated in FIG. 2 and described above will now be presented in more detail.

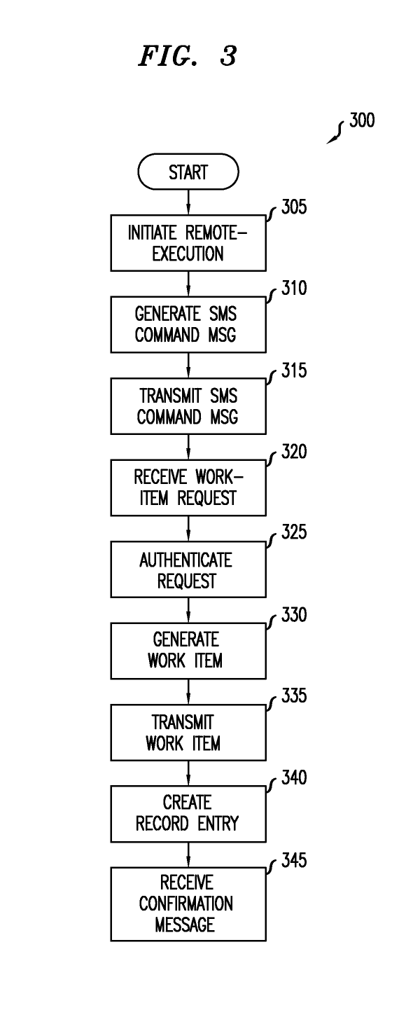

FIG. 3 is a flow diagram illustrating a method 300 of remotely executing an application on a mobile device according to an embodiment of the present invention. Again, at START it is assumed that the equipment for performing the method is available and operational. Note that it is also presumed that the mobile device has been appropriately configured for the command recognition and authentication processes. That is, while the term ‘mobile device’ broadly includes all mobile electronic communication devices, this does not imply that any or all of such devices are currently configured to take advantage of the remote-execution process of the present invention. It is expected, however, that the wireless service provider will perform the necessary reconfiguration and may even provide some incentive to the subscriber for permitting this to be done. In one embodiment, for example, the service provider installs the public key components of two Authenticode certificates to be used to verify the integrity of the SMS message contents, and the integrity of the downloaded work item. The certificate used to verify the integrity of the SMS message contents may be, for example, a DSA (digital signature algorithm) certificate having a name configured appropriately for the mobile device to find. As another example, the certificate used by to verify the integrity of a downloaded work item may be an RSA (Rivest, Sharmir, Adelman) certificate belonging to the service provider. The particular capabilities required of the mobile device will be apparent or described along with the description of the present invention herein.

The method 300 begins with initiation of the remote-execution (step 305) in a remote-execution server. Note that the remote execution server is not a specific device in a typical network, but rather whatever server is in a particular case going to perform the operations described here. The initiation 305 is simply the receipt of an instruction to proceed. This instruction may have been automatically generated or manually input by a human operator.

In other cases initiation 305 may have been triggered by an operation that the user of the mobile device is attempting to perform. For example, a subscriber may try to run an application that is part of their subscription, but their mobile device is not yet properly configured to do so. Instead of generating an error message, the network may automatically initiate the necessary changes using a process according to the present invention—perhaps without the subscriber even being aware of the changes being to their mobile device.

In any event, when the initiation has been received at step 305, a remote-execution SMS command message is generated (step 310). The SMS message includes a hook, that is, an indicator recognizable by the mobile device and indicating that it is a remote-execution command message. The hook may be, for example, the formatting of the SMS message in a certain manner or the inclusion of a recognizable string of characters. In this embodiment, the SMS message also includes an authentication signature, usable by the mobile device to verify the authenticity of the SMS message. Preferably, the authentication signature is encrypted and enables the mobile device to determine that the SMS message is complete and has not been tampered with. Finally, the SMS message includes the identity of the sender and a remote-execution command. In this sense, the identity of the sender may both facilitate confirming the legitimacy of the message and provide a way to contact the sender for execution of the process. Of course, the identity of the sender may be evident from the authentication signature, and contact information may be included in the remote-execution command itself. In other words, the constitutive parts of the SMS remote-execution command message are not necessarily separate component parts of the message. The remote execution SMS message is then transmitted (step 315) to the mobile device.

Note also that the term ‘SMS message’, while generally referring to the commonly-understood short message service messages currently in use (though not necessarily as constituted according to the present invention), may also include any similar types of messages, however denominated, when assembled according to the basic parameters described above.

As noted above, the mobile device must be operable to recognize the hook placed in the SMS message, to authenticate the message, and to execute the remote execution-command. This capability may of course be included in new mobile devices, but older ones are expected to require reconfiguration. For this reason, if a mobile device does not respond to the SMS remote-execution command message after a period of time has elapsed, then a text message may be transmitted encouraging the user to contact the wireless provider for an upgrade. Prior to sending such a message, however, the network may be queried to determine if the mobile device is actually accessible, for example if it appears to be registering regularly (steps not shown). If not, the mobile device may be out of range or simply turned off, and no reminder message is necessary. Of course, in some implementations, the wireless provider may keep track of mobile devices that have been configured for remote execution, and the server may initially query a wireless provider profile database in an attempt to determine whether this has been done.

Returning to the embodiment of FIG. 3, it will be presumed that the mobile device is active and properly configured for operation according to the present invention. The process then continues when a work-item request is received (step 320) from the mobile device. The remote-execution server then authenticates the request (step 325). Part of this process may be simply verifying that a remote-execution command SMS message had in fact been sent to the requesting mobile device, but preferably an included authentication signature is verified as well. Note, however, that this authentication 325 is optional—in some other cases the work item will simply be provided to any entity requesting it.

In this embodiment, after the work-item request has been authenticated, a work item is generated (step 330). In this embodiment, the work item includes the software to be executed on the mobile device and content or data that is being made available to the mobile device in this way. In some cases, only software or only content will be in a particular work item, depending on the needs of the particular process. The work item preferably also includes an authentication signature, and both the signature and other content are encrypted. In addition, the work item will contain any additional commands or instructions necessary, if any, to the remote installation and execution. Some or all of the work item contents are compressed for more efficient transmission, for example by creating a ZIP file.

Once the work item has been created and otherwise prepared it is transmitted (step 335) to the mobile device. In this embodiment, a record entry is then created (step 340) so that the remote-execution server, when sending another remote execution command is aware that this mobile device is remote execution command ready and, preferably, so that a server is aware of which work items have been sent to which mobile device. In any case, the record may also include an indication that (or whether) the remote execution was successfully completed, usually as reported by the mobile device in a confirmation message (step 345).

As should be apparent, some knowledge of the requesting mobile device's capabilities and current configuration may be helpful to the remote-execution server when creating a work item, as described above. A database may be maintained at the remote-execution server or elsewhere by the wireless provider for keeping track of this information. Although a query to such a database is not explicitly shown in FIG. 3, it may be added at whatever point in the process it appears useful to the provider.

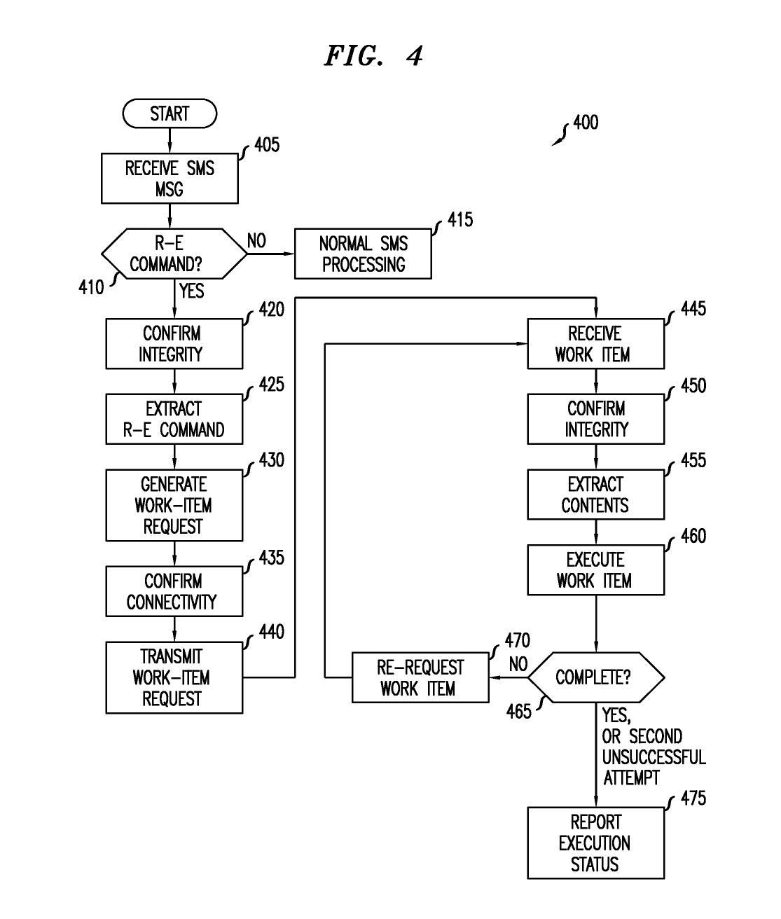

FIG. 4 is a flow diagram illustrating a method 400 of remotely executing an application on a mobile device according to an embodiment of the present invention. Again, at START, it is assumed that the equipment for performing the method is available and operational, and that the mobile device has been appropriately configured for the command recognition and verification processes. In this embodiment, the process then begins with the receipt (step 405) of an SMS message at the mobile device. Since the mobile device has been configured for operation according to the present invention, the SMS message is scanned and analyzed to determine (step 410) whether it is in fact an remote-execution command SMS message, that is, whether is contains a hook (as described above, for example).

In this embodiment, if the SMS message received at step 405 does not include a remote-execution (R-E) hook, then it is processed (step 415) as a normal SMS message. If, on the other hand, the message does include a remote-execution hook, its integrity is confirmed (step 420). In a preferred embodiment, this includes an authentication and confirming that the remote execution SMS message has not been tampered with (not separately shown). Once the integrity of the message is confirmed, the remote execution command is extracted (step 425) and a work-item request is generated (step 430). The work item request does not require a specific format, but in this embodiment should include an authentication signature or other measure for confirming authenticity (if one is required).

In most embodiments, the contents of the request will be somewhat dictated by the SMS remote-execution command message, which will include an address for retrieving the work item, for example an IP address or URL for items being retrieved via HTTP (Hypertext Transfer Protocol) or HTTPS (HTTP secure). In this regard it is noted that the work-item request may be transmitted in different ways, but if is to be sent through a data network, the request may be buffered (or simply not generated) until the appropriate connectivity is available. In this embodiment, once connectivity is confirmed (step 435) the work-item request is transmitted (step 440). If for some reason the work-item request cannot be sent within a certain time after the remote execution SMS command message is received, then the mobile device may transmit an SMS message (not shown) to indicate that execution is being delayed, or that another remote execution command message should be sent at a later time.

In the embodiment FIG. 4, the mobile device then receives the work item (step 440) from the remote execution server or other entity. The received work item is then authenticated or its integrity otherwise confirmed (step 450). If the work item is authenticated, then its contents are extracted (step 455) and executed (step 460). The exact steps for execution will, of course, vary depending on the operation to be performed. In a preferred embodiment, the mobile device then verifies that the execution was successfully completed (step 465). If for some reason it was not, the mobile station may send a second request (step 470) for a work item, and steps 445 through 465 are repeated. Additional requests (not shown) may be sent, if the application can still not be executed successfully, but of course in most cases this process cannot be carried out indefinitely. In this embodiment, the presumption is made that only a second attempt will be made.

In any event, it is preferred that the results of the attempted execution be reported (step 475) to the remote execution server or some other entity specified in the work item. In some cases, if a negative result is reported, another remote execution SMS command message may be received. For convenience, it is presumed that receipt of a new command message begins the process again, regardless of whether previous attempts have been unsuccessful. Finally, in this embodiment, whether the execution is successful or not, the application and data files necessary for the execution but not for further operation are then deleted.

Note that the methods described above are intended to be exemplary and not limiting. The sequence of operations presented may vary in other embodiments; the steps of each process may be performed in any logically-consistent order. In alternate embodiments, certain steps may be added or, in some cases, removed, without departing from the spirit of the invention.

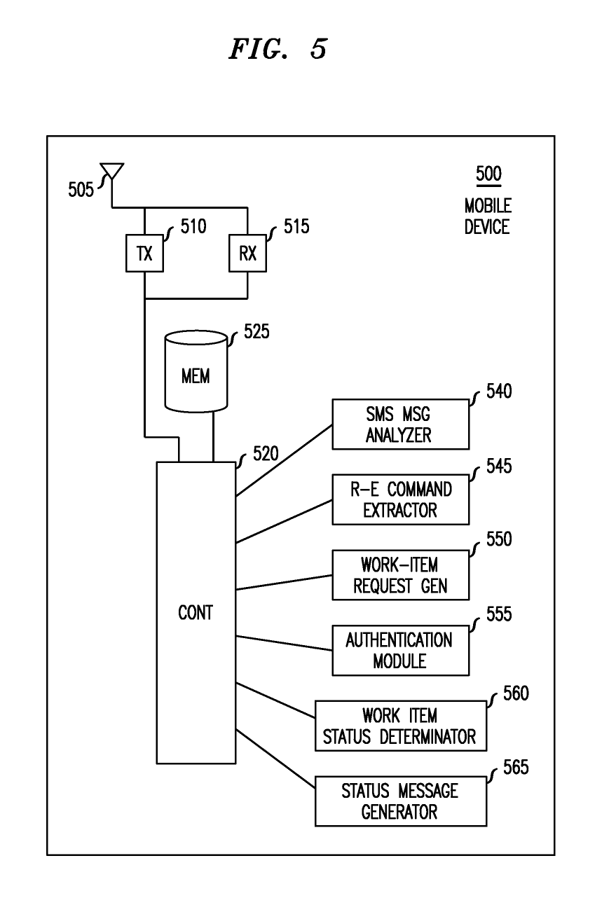

FIG. 5 is a simplified block diagram illustrating selected components of a mobile device 500 according to an embodiment of the present invention. In this embodiment, mobile device 500 includes a transmit circuitry 510 and a receive circuitry 515 for wireless communication through antenna 505 with a wireless communication network such as wireless network 100 or access network 140 shown in FIG. 1. Transmit circuitry 510 and a receive circuitry 515 operate under the control of controller 520, which generally controls the function of memory device 525 as well. Memory device 525 may be used for storing operational programs and data, as well as buffering or saving messages sent and received when necessary.

According to this embodiment of the present invention, the mobile device 500 also includes an SMS message analyzer for analyzing received SMS messages to determine if they are remote-execution command messages and an remote-execution command extractor 545 to extract the remote-execution commands if they are. A work-item request generator 550 is used to generate work-item requests as indicated by the remote-execution command message to be transmitted via transmit circuitry 510. When a work item is received in response to the work-item request, it is executed by the controller 520 and memory 525, as supported by the other components of mobile device 500 as necessary.

In the embodiment of FIG. 5, the mobile device 500 also includes an authentication module 555 for confirming the integrity of received remote-execution command messages and work items. Preferably, authentication module confirms encrypted authentication signature contained in the received items using a public key obtained for this purpose.

Finally, in this embodiment, mobile device 500 includes a work-item status determiner to determine whether a work item has been successfully executed. If so, the temporary data and program files associated with the work item may be deleted. In any event, mobile device 500 also includes a work-item status message generator for generating a message that may be transmitted to the wireless provider or some other entity to report whether the execution was successful.

Note that FIG. 5 is an exemplary embodiment of a mobile device configured according to one embodiment of the present invention. Other embodiments are possible. For example, some of the components separately identified in FIG. 5 may in other embodiments be combined with others, or further divided into separate components. Other components maybe present of course, and in some cases omitted without departing from the spirit of the invention.

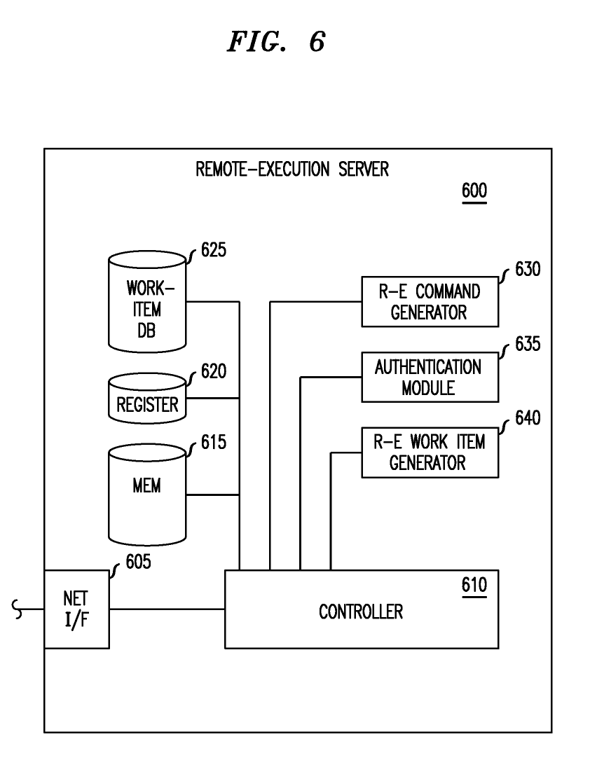

FIG. 6 is a simplified block diagram illustrating selected components of a remote-execution server 600 according to an embodiment of the present invention. In this embodiment, remote-execution server 600 includes a network interface 605 for communicating with a network such as access network 140 shown in FIG. 1. Network interface 605 operates under the control of controller 610, as does memory device 615. Memory device 615 may be used for storing operational programs and data, as well as buffering or saving messages sent and received when necessary.

In the embodiment of FIG. 6, a register 620 is illustrated separately. In accordance with the present invention, register 620 stores mobile device profiles, if available, which preferably contain information about which mobile stations are configured for remote-execution, and which mobile devices have successfully executed or been sent specific work items or the remote-execution command messages associated with them. In an alternate embodiment, some or all of this information may be stored in another location such as an HLR (home location register) or HSS (home subscriber server) associated with a wireless provider. When the work items are formed, they are stored in work-item database 625, also illustrated separately in FIG. 6.

In accordance with this embodiment of the present invention, remote-execution server 600 also includes a remote-execution command message generator 630 for generating remote-execution command messages to be sent to one or more mobile stations via network interface 605. A work-item generator 640 is also present to form work items to be stored in work-item database 625 or transmitted to a mobile device, or both.

In the embodiment of FIG. 6, the remote-execution server 600 also includes an authentication module 635 for confirming the integrity of received remote-execution work item requests, if required, and for adding encrypted authentication signatures (for example, corresponding to the Authenticode certificates mentioned above) to remote-execution command messages and work items using a private key generated for this purpose.

Note that FIG. 6 is an exemplary embodiment of a remote-execution server configured according to one embodiment of the present invention. Other embodiments are possible. For example, some of the components separately identified in FIG. 6 may in other embodiments be combined with others, or further divided into separate components. Other components maybe present of course, and in some cases omitted without departing from the spirit of the invention.

In this manner, the present invention provides for the remote installation and execution of software in mobile devices, securely and without the for subscriber participation or, optionally, with minimal participation.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for remotely executing software on a mobile device, comprising:
forming on a server a work item comprising the software;
transmitting to the mobile device an remote-execution command message comprising a remote-execution command and the address of the server;
receiving a work-item request from the mobile device; and
transmitting the work item to the mobile device in response to the work item request.

2. The method according to claim 1, further comprising receiving an execution status message from the mobile device.

3. The method according to claim 2, further comprising creating a record entry in a database indicating the status of the remote execution.

4. The method according to claim 1, wherein the work item comprises an authentication signature.

5. The method according to claim 1, wherein the remote-execution command message comprises an authentication signature.

6. The method according to claim 1, wherein the remote-execution command message is an SMS message.

7. The method according to claim 6, where in the SMS message comprises an indication recognizable to the mobile device that it is an remote-execution command message.

8. The method according to claim 7, wherein the recognizable indication is the manner in which the SMS message is formatted.

9. The method according to claim 1, further comprising determining the integrity of the work-item request.

10. The method according to claim 1, further comprising transmitting a query to the mobile device if a message indicating successful execution has not been received within a predetermined time subsequent to transmitting the work item.

11. A method for remotely executing software on a mobile device, comprising:
receiving a remote-execution command message at the mobile device;
confirming the integrity of the remote-execution command message;
transmitting a work item request if the integrity of the remote-execution command message is confirmed;
receiving a work item;
confirming the integrity of the work item; and
executing the work item.

12. The method according to claim 11, wherein the remote-execution command message is an SMS message, and further comprising determining whether an SMS message received at the mobile device is an remote-execution command message.

13. The method according to claim 11, wherein confirming the integrity of the remote-execution command message comprises confirming an authentication signature in the remote-execution command message.

14. The method according to claim 11, wherein confirming the integrity of the remote-execution command message comprises determining whether the message originator identified the remote-execution command message is the same as the sender from whom the message was received.

15. The method according to claim 11, further comprising determining whether the work item has been successfully executed.

16. The method according to claim 15, further comprising transmitting a remote-execution status report message.

17. The method according to claim 16, further comprising transmitting an additional work-item request if it is determined that the work item has not been successfully executed.

18. The method according to claim 11, further comprising presenting on a display of the mobile device an indication of whether the work item has been executed.

19. The method according to claim 11, further comprising configuring the mobile device to be operable to remotely install and execute software according to claim 11.

20. A remote-execution server for remotely executing software on a mobile device, the remote-execution server comprising:
a work-item generator for forming a work item comprising software to be executed on the mobile device;
a remote-execution command message generator for generating a message to instruct the mobile device to download the work item;
an authentication module for inserting authentication signatures in work items and remote-execution command messages prior to transmission;
a network interface for transmitting work item and the remote-execution command message prior to transmission; and
a controller for controlling the components of the remote-execution server.
